(19) United States
(12) Patent Application Publication
(10) Pub. No.: US 2026/0357631 A1
(43) Pub. Date: Nov. 12, 2026

(54) MANAGING A DOOR CLOSER

(71) Applicant: ASSA ABLOY AB, Stockholm (SE)

(72) Inventors: Martin Englund, Handen (SE); Jonas Merkland, Järfälla (SE); Johan Von Matern, Täby (SE); Daniel Skarp, Enebyberg (SE)

(21) Appl. No.: 19/137,101

(22) PCT Filed: Dec. 13, 2023
(86) PCT No.: PCT/EP2023/085493

§ 371 Date: Jun. 9, 2025

(30) Foreign Application Priority Data
Dec. 14, 2022 (SE) 2251456-6

(51) Int. Cl. E05F 3/22; E05F 1/10; E05F 15/60; E05F 15/71

(52) U.S. Cl. CPC E05F 3/22; E05F 1/10; E05F 15/60; E05F 15/71; E05Y 2201/21; E05Y 2201/408; E05Y 2201/41; E05Y 2400/302; E05Y 2400/616; E05Y 2900/132

(57) ABSTRACT

It is provided a method for managing a door closer (1) for closing a door (15). The door closer (1) comprises a generator (6) and an energy storage device (7). The method is performed by the door closer (1). The method comprises: obtaining (40) a target parameter for the door closer; obtaining (44) at least one measurement when a door closing operation of the door closer is in progress; and adjusting (46), based on the at least one parameter, braking of the door closer to approach the target parameter. Corresponding door closer, computer program and computer program product are also provided.

WO

### TECHNICAL FIELD

The present disclosure relates to the field of managing a door closer, and in particular to managing a door closer comprising a generator and an energy storage device.

### BACKGROUND

Door closers have been used for a long time to provide reliable closing of doors. This function can e.g. be used to improve physical security, climate control or to adhere to fire regulations. Traditional door closers are based on mechanical energy storage that is loaded during opening. The mechanical energy is exploited to close the door. Hydraulics or pneumatics can be used to control the speed of closing to prevent slamming.

It has been proposed to provide door closers with a generator to convert mechanical energy from the door closing to electrical energy. However, the performance of such door closers might not be optimal.

### SUMMARY

One object is to improve control of a door closer comprising a generator.

According to a first aspect, it is provided a method for managing a door closer for closing a door. The door closer comprises a generator and an energy storage device. The method is performed by the door closer. The method comprises: obtaining a target parameter for the door closer; obtaining at least one measurement when a door closing operation of the door closer is in progress; and adjusting, based on the at least one parameter, braking of the door closer to approach the target parameter.

The target parameter may be a door closing duration.

The target parameter may be a door closing speed, that varies depending on an opening angle of the door.

The adjusting the braking may comprise adjusting an impedance as seen from the generator.

The adjusting the impedance may comprise applying pulse width modulation.

The generator may be a multi-phase generator, in which case the adjusting the impedance comprises short-circuiting at least two phases of the generator.

The adjusting the impedance may comprise short-circuiting all phases of the generator (with each other).

The adjusting the impedance may comprise adjusting an impedance between the generator and the energy storage device.

The adjusting an impedance between the generator and the energy storage device may comprise connecting or disconnecting at least one impedance between the generator and the energy storage device.

The target parameter may be a temperature proximate to a temperature-sensitive component, in which case the at least one measurement comprises a current temperature proximate to a temperature-sensitive component, and the adjusting the braking comprises avoiding connecting an impedance proximate to the temperature-sensitive component when the current temperature proximate to a temperature-sensitive component is greater than the target.

The target parameter may be a target amount of energy stored in the energy storage device, in which case the at least one measurement comprises a current amount of energy stored in the energy storage device, and the adjusting the braking comprises adjusting the braking to reduce energy transfer from the generator to the energy storage device when the current amount of energy stored in the energy storage device is greater than the target.

The target parameter may be a target amount of energy stored in the energy storage device, in which case the at least one measurement comprises a current amount of energy stored in the energy storage device, and the adjusting the braking comprises adjusting the braking to increase energy transfer from the generator to the energy storage device when the current amount of energy stored in the energy storage device is less than the target.

The target parameter may be a target amount of energy stored in the energy storage device, may be the method further comprises: using the generator for energy capture during door opening when the current amount of energy stored in the energy storage device is less than the target.

The method may further comprise: determining the applied braking is insufficient; and sending a signal indicating that an abnormal braking is required.

The braking may be insufficient when applied braking is above a threshold amount of braking.

The braking may be insufficient when applied braking is not sufficient for the target parameter to be reached.

The obtaining at least one measurement and the adjusting braking of the door closer may be repeated a plurality of times during the door closing operation.

The method may further comprise, prior to the obtaining at least one measurement: measuring a first baseline duration, indicating a duration of closing the door during maximum braking of the door closer; and measuring a second baseline duration, indicating a duration of closing the door during minimum braking of the door closer.

According to a second aspect, it is provided a door closer for closing a door.

The door closer comprises: a generator; an energy storage device; a processor; and a memory storing instructions that, when executed by the processor, cause the door closer to: obtain a target parameter for the door closer; obtain at least one measurement when a door closing operation of the door closer is in progress; and adjust, based on the at least one parameter, braking of the door closer to approach the target parameter.

According to a third aspect, it is provided a computer program for managing a door closer for closing a door, the door closer comprising a generator and an energy storage device. The computer program comprises computer program code which, when executed on a door closer, causes the door closer to: obtain a target parameter for the door closer; obtain at least one measurement when a door closing operation of the door closer is in progress; and adjust, based on the at least one parameter, braking of the door closer to approach the target parameter.

According to a fourth aspect, it is provided a computer program product comprising a computer program according to the third aspect and a computer readable means comprising non-transitory memory in which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 is a schematic diagram illustrating an environment in which embodiments presented herein can be applied;

FIG. 2 is a schematic diagram illustrating components of the door closer of FIG. 1 according to one embodiment;

FIG. 3 is a schematic diagram illustrating one embodiment of an energy converter of FIG. 2;

FIGS. 4A-D are schematic diagrams illustrating various ways of controlling impedance in the door closer of FIG. 1 and FIG. 2;

FIG. 5 is a flow chart illustrating embodiments of methods for managing a door closer for closing a door; and

FIG. 6 shows one example of a computer program product comprising computer readable means.

### DETAILED DESCRIPTION

The aspects of the present disclosure will now be described more fully hereinafter with reference to the accompanying drawings, in which certain embodiments of the invention are shown. These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

Embodiments presented herein provide dynamic braking of a door closer. In the door closer, mechanical energy is converted to electrical energy by a generator in the door closing process, allowing the energy to be harvested and stored in an energy storage device. The dynamic braking is achieved by controlling electrical impedance on the electrical side, which thereby controls mechanical resistance on the mechanical side. The dynamic braking can be used to achieve desired mechanical movement resistance, e.g. in different phases of the door closing. Furthermore, the dynamic braking can be employed to control how much energy is supplied to the energy storage device. In one embodiment, when the amount of energy is very low in the energy storage device, the generator is used also during door opening, to increase the amount of energy that is converted and harvested to electrical energy. When the energy level is high the device may perform additional tasks, such as being a routing node in a mesh network, provide assistance to door opening, etc. The performance of the dynamic braking can be evaluated to determine when the door closer may need maintenance. The dynamic braking may also be used during installation to help the installer correctly tune the mechanics.

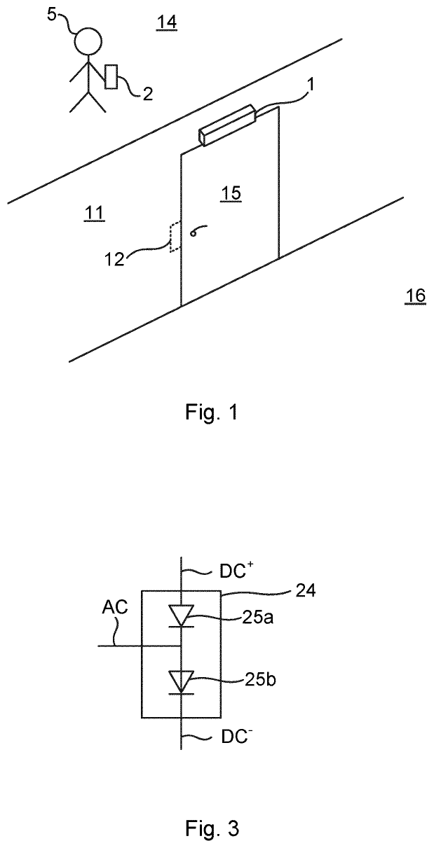

FIG. 1 is a schematic diagram illustrating an environment in which embodiments presented herein can be applied. Access to a first physical space 16 is restricted by a door 15, which is optionally selectively unlockable. The door 15 stands between the first physical space 16 and a second physical space 14. The first physical space 16 can be inside the door 15 and the second physical space 14 can be outside the door 15. In order to unlock or lock the door 15, an electronic lock 12 is optionally provided. The barrier 15 is provided in a surrounding fixed structure 11, such as a wall or fence.

A user 5 is in the vicinity of the electronic lock 12. Optionally, the user carries an electronic key 2 in any suitable format that allows the electronic lock 12 to communicate (wirelessly or conductively) with the electronic key 2 to evaluate whether to grant access. For instance, the electronic key 2 can be in the form of a key fob, a key card, a hybrid mechanical/electronic key or embedded in a smartphone.

A door closer 1 is provided to provide controlled automatic closing of the door 15 after it is opened. When the user 5 opens the door 15, a spring in the door closer 1 is deformed (e.g. extended, rotated, etc.) and is thereby loaded with mechanical energy. When the user 5 passes through the doorway and releases the door 15, the mechanical energy in the spring causes the door to close again. The door closer 1 can be provided such that is fixed both to the door 15 and the surrounding structure 11, to allow the spring to be loaded with mechanical energy when the door 15 opens, that is subsequently exploited to close the door. As explained in more detail below, the door closer 1 comprises a generator and an energy storage device, which converts part of the mechanical energy to electric energy. The electric energy can be used by the door closer e.g. for auxiliary functions, such as for communicating with external devices, for powering one or more sensors for detecting people and/or door status, for controlling fail-safe hold-open functionality, etc.

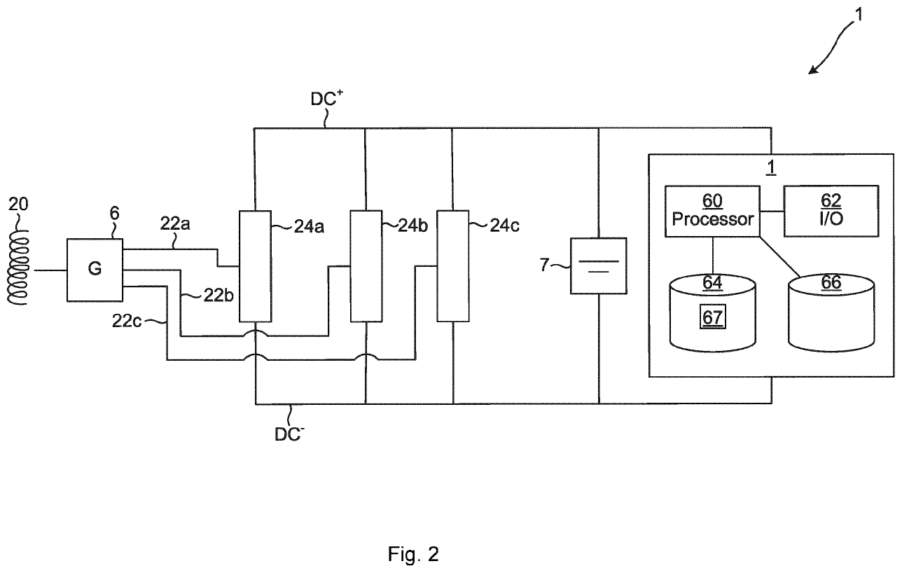

FIG. 2 is a schematic diagram illustrating components of the door closer 1 of FIG. 1 according to one embodiment.

The door closer comprises a spring 20, that is loaded with mechanical energy when the door is opened. The spring can be of any type that enables storage of mechanical energy when the door is opened, for instance, a coil spring, torsion spring, etc. A generator 6 is used to convert at least part of the mechanical energy stored in the spring 20 to electrical energy, e.g. when the door is closing. The door closer 1 can comprise various mechanical elements, such as gears, etc. (not shown) to provide mechanical energy of suitable characteristics for the generator 6, as well as for controlling closing times, torques and/or speeds of the closing door. In FIG. 2, the spring 20 is only shown schematically connected to provide mechanical energy to the generator 6.

The generator 6 provides electrical energy in the form of alternating current (AC), in one or more phases. In the embodiment shown in FIG. 2, there is AC electrical energy 22a, b, c output from the generator 6 in three phases. However, it is to be noted that a single-phase (or any other number of phases) generator 6 can equally be used in the door closer, e.g. any suitable rotating electrical machine, such as a DC motor or an AC motor operating in generator mode.

The AC energy is converted to direct current (DC) in respective energy converters 24a-c, where the DC energy is provided on a positive DC bus DC+ and a negative DC bus DC−. The negative DC bus DC− can also be considered to be ground.

Once converted to DC, the energy can be stored in an energy storage device 7. The energy storage device 7 can e.g. be in the form of a battery, capacitor, supercapacitor or inductor. The energy storage device 7 can contain a single energy storage element or a plurality of energy storage elements. Optionally, energy could also be stored mechanically, e.g. in a spring.

The electrical energy in the energy storage device 7 can be used to power a processor 60, a memory 64, a data memory and an I/O interface 62, and optionally any auxiliary sensors and/or actuators.

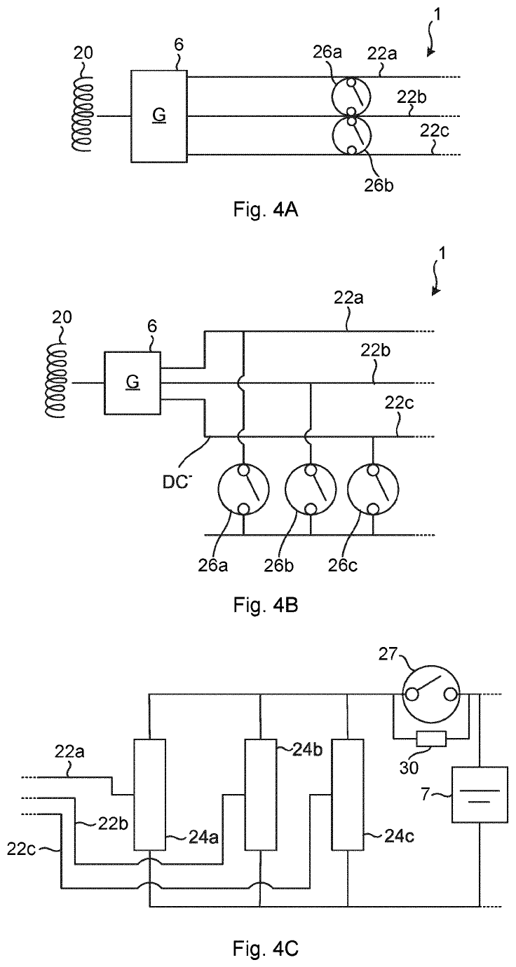

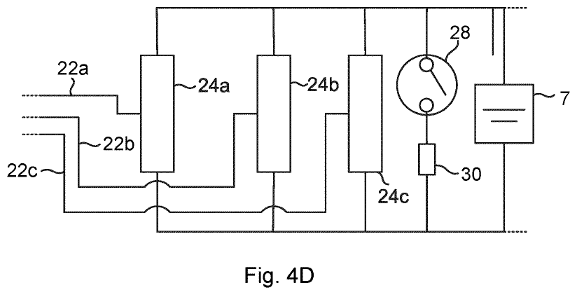

The processor 60 is provided using any combination of one or more of a suitable central processing unit (CPU), graphics processing unit (GPU), multiprocessor, neural processing unit (NPU), microcontroller, digital signal processor (DSP), etc., capable of executing software instructions 67 stored in a memory 64, which can thus be a computer program product. The processor 60 could alternatively be implemented using an application specific integrated circuit (ASIC), field programmable gate array (FPGA), etc. The processor 60 can be configured to execute the method described with reference to FIG. 4 below.

The memory 64 can be any combination of random-access memory (RAM) and/or read-only memory (ROM). The memory 64 also comprises non-transitory persistent storage, which, for example, can be any single one or combination of magnetic memory, optical memory, solid-state memory or even remotely mounted memory.

A data memory 66 is also provided for reading and/or storing data during execution of software instructions in the processor 60. The data memory 66 can be any combination of RAM and/or ROM.

The door closer 1 further comprises an I/O interface 62 for communicating with external and/or internal entities. For instance, the I/O interface 62 can comprise a short-range wireless interface to communicate with an electronic lock or a gateway, e.g. based on Bluetooth Low Energy (BLE), Bluetooth, UHF, ZigBee, any of the IEEE 802.11 standards, any of the IEEE 802.15 standards, wireless Universal Serial Bus (USB), etc.

Other components of the door closer 1 are omitted in order not to obscure the concepts presented herein.

FIG. 3 is a schematic drawing of an energy converter 24 being any one of the energy converters 24a-c of FIG. 2 according to one embodiment. The energy converter 24 converts AC energy provided on its AC input to DC energy provided on the DC buses DC+, DC−. The energy converter here comprises a pair of diodes 25a-b: an upper diode 25a between the AC terminal and the positive DC bus DC+ and a lower diode 25b between the AC terminal and the negative DC terminal DC−. It is to be noted that energy converter 24 can e.g. be implemented based on any other suitable converter structure, e.g. based on actively controlled rectification based on transistors and/or thyristors, controlled by rectification control circuitry.

FIGS. 4A-D are schematic diagrams illustrating various embodiments of controlling an impedance between the generator and the energy storage device of the door closer 1 of FIG. 2. In general, reduced impedance result in increased braking. The switches mentioned can be any suitable type of switch e.g. transistor, etc.

In FIG. 4A, two switches 26a-b are provided to allow all three AC phases to be short-circuited with each other.

In FIG. 4B, three switches 26a-b are provided to allow individual control of when to short-circuit each phase AC phase with the negative DC bus DC−.

In the embodiments of FIG. 4A-B, impedance is very low, essentially only the resistance of the windings in the generator 6. This results in a large mechanical resistance, i.e. that there is a large mechanical braking. The short-circuiting between phases also increases voltage supplied from the generator.

In FIG. 4C, an impedance 30 is provided between the energy converters 24a-c and the energy storage device 7. A bypass switch 27 is provided to control when the impedance 30 should be in the path between the energy converters 24a-c and the energy storage device 7. It is to be noted that the impedance 30 and the bypass switch 27 can be provided anywhere between the generator and the energy storage device. Optionally, multiple impedances and bypass switches are provided at the same or different locations, to increase granularity of the impedance that is applied, and thus greater granularity of the braking that is applied. Whenever an impedance component is described herein, this can contain any single one or more components that result in an impedance in the circuit that it is provided. For instance, the impedance component can comprise any one or more of a resistor, a capacitance and/or an inductor. In one embodiment, the impedance component is made up of a single resistor, providing an impedance that is more or less constant in relation to variations in current and voltage across the component.

In FIG. 4D, an impedance 30 is provided in a leg provided in parallel to the energy storage element. The leg also comprises a control switch 28 controlling when current should pass from the positive DC bus DC+ to the negative DC bus DC− via the impedance.

It is to be noted that the embodiments of FIGS. 4A-D can be combined freely to provide a desired amount of impedance.

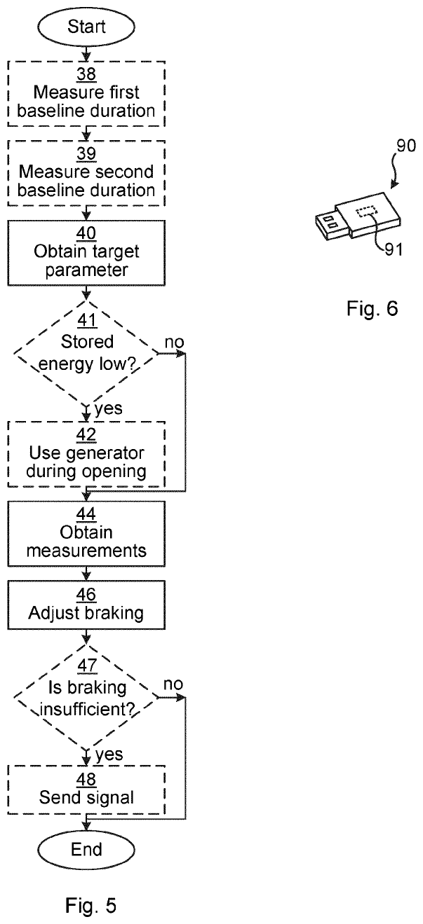

FIG. 5 is a flow chart illustrating embodiments of methods for managing a door closer for closing a door. The method is performed by the door closer 1.

In an optional measure first baseline duration step 38, the door closer 1 measures a first baseline duration. The first baseline duration indicates a duration of closing the door during maximum braking of the door closer, e.g. by short-circuiting the AC terminals, as mentioned above with reference to FIGS. 4A-B.

In an optional measure second baseline duration step 39, the door closer 1 measures a second baseline duration, indicating a duration of closing the door during minimum braking of the door closer, e.g. by adding a serial impedance 30, as shown in FIG. 4C, or a parallel impedance as shown in FIG. 4D and mentioned above.

It is to be noted that more baseline durations and/or measurements can be obtained at this stage.

In an obtain target parameter step 40, the door closer 1 obtains a target parameter for the door closer. The target parameter can be of different types depending on how the door closer should be controller.

In one embodiment, the target parameter is a door closing duration. This door closing duration can be a default setting for the door closer or a setting that an installer or maintenance personnel sets to provide a good user experience and reliable closing of the door for increased security and safety.

In one embodiment, the target parameter is a door closing speed, that varies depending on an opening angle of the door 15. For instance, the door closing speed can be configured to increase when the door is closing and the angle of opening is less than a threshold angle. The increased speed at the end makes the door latch properly in the door closing process. At the same time, the speed can be kept relatively slow to prevent slamming of the door during the closing. Alternatively or additionally, the door closing speed can be reduced if more people are detected, allowing more people to pass through in a more convenient and safe manner.

In one embodiment, the target parameter is a target amount of energy stored in the energy storage device 7. In this embodiment, there is an optional conditional stored energy low step 41. If the stored energy is low (e.g. lower than a threshold amount), the method proceeds to an optional use generator during opening step 42. Otherwise, the method proceeds to an obtain measurements step 44.

In the optional use generator during opening step 42, the door closer 1 uses the generator 6 for energy capture during door opening (which is thus performed when the current amount of energy stored in the energy storage device 7 is less than the target). This captures energy also during the opening of the door, thus effectively increasing the amount of energy that is harvested in the cycle of door opening and door closing. Using steps 41 and 42, the door closer automatically adapts to a situation e.g. where the door is not opened very often, whereby additional energy to be harvested to for the door closer 1 to function as desired.

In an obtain measurement(s) step 44, the door closer 1 obtains at least one measurement when a door closing operation of the door closer is in progress.

In an adjust braking step 46, the door closer 1 adjusts, based on the at least one parameter, braking of the door closer to approach the target parameter.

In one embodiment, the adjusting the braking comprises adjusting an impedance as seen from the generator 6. This can be achieved by short-circuiting the AC phases, as shown in FIGS. 4A-B and explained above and/or by connecting or disconnecting one or more impedances in the path from the generator to the energy storage device.

In one embodiment, the adjusting the impedance comprises applying pulse width modulation to achieve a proportion of the effect between fully applied connection and disconnection of an impedance or short-circuit. This works well due to the inertia of current change provided by the inductance of the generator.

In one embodiment, the generator 6 is a multi-phase generator, and the adjusting the impedance comprises short-circuiting at least two phases of the generator 6, as illustrated in FIGS. 4A-B and described above.

In one embodiment, the adjusting the impedance comprises short-circuiting all phases of the generator 6 (with each other), which is also possible using the circuits of FIG. 4A and FIG. 4B.

In one embodiment, the adjusting the impedance comprises adjusting an impedance between the generator 6 and the energy storage device 7, e.g. as shown in FIG. 4C and FIG. 4D and explained above.

In one embodiment, the adjusting an impedance between the generator 6 and the energy storage device 7 comprises connecting or disconnecting at least one impedance between the generator 6 and the energy storage device 7, e.g. as shown in FIG. 4C and FIG. 4D and explained above.

The obtain measurements step 44 and adjust braking step 46 can be repeated a plurality of times during the door closing operation. This achieves a truly dynamic control of the door closer. Optionally, also the obtain target parameter step 40 is also part of at least some iterations, enabling the target parameter to vary over the duration of a single door closing operation.

In one embodiment, the target parameter is a temperature proximate to a temperature-sensitive component. In this case, the at least one measurement comprises a current temperature proximate to a temperature-sensitive component. Furthermore, the adjusting the braking comprises avoiding connecting an impedance proximate to the temperature-sensitive component when the current temperature proximate to a temperature-sensitive component is greater than the target. Since an impedance that consumes energy heats up, this embodiment prevents using an impedance that can provide heat to a temperature-sensitive component, whenever possible.

In one embodiment, the target parameter is a target amount of energy stored in the energy storage device 7. In this case, the at least one measurement comprises a current amount of energy stored in the energy storage device 7. Furthermore, the adjusting the braking comprises adjusting the braking to reduce energy transfer from the generator 6 to the energy storage device 7 when the current amount of energy stored in the energy storage device 7 is greater than the target. This embodiment prevents overcharging the energy storage device 7.

In one embodiment, the target parameter is a target amount of energy stored in the energy storage device 7. In this case, the at least one measurement comprises a current amount of energy stored in the energy storage device 7. Furthermore, the adjusting the braking comprises adjusting the braking to increase energy transfer from the generator 6 to the energy storage device 7 when the current amount of energy stored in the energy storage device 7 is less than the target. This embodiment provides more energy to the energy storage device 7 when its stored energy is low.

In an optional conditional is braking insufficient step 47, the door closer 1 determines whether the applied braking is insufficient. In one embodiment, the braking is insufficient when applied braking is above a threshold amount of braking. In one embodiment, the braking is insufficient when applied braking is not sufficient for the target parameter to be reached. When braking is insufficient, the method proceeds to an optional send signal step 48. Otherwise, the method ends, or restarts.

In the optional send signal step 48, the door closer 1 sends a signal indicating that an abnormal braking is required. This can be used as an indicator that the door closer 1 needs service or maintenance to continue functioning correctly. When this step is performed when the braking is above the threshold amount of braking, but the braking is still sufficient, maintenance can hopefully be performed on the door closer 1 before the door closer 1 is in a state where it cannot provide sufficient braking.

FIG. 6 shows one example of a computer program product 90 comprising computer readable means. On this computer readable means, a computer program 91 can be stored in a non-transitory memory. The computer program can cause a processor to execute a method according to embodiments described herein. In this example, the computer program product is in the form of a removable solid-state memory, e.g. a Universal Serial Bus (USB) drive. As explained above, the computer program product could also be embodied in a memory of a device, such as the computer program product 64 of FIG. 2. While the computer program 91 is here schematically shown as a section of the removable solid-state memory, the computer program can be stored in any way which is suitable for the computer program product, such as another type of removable solid-state memory, or an optical disc, such as a CD (compact disc), a DVD (digital versatile disc) or a Blu-Ray disc.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims. Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1-21. (canceled)

22. A method for managing a door closer for closing a door, the door closer comprising a generator and an energy storage device, the method being performed by the door closer, the method comprising:
obtaining a target parameter for the door closer;
obtaining at least one measurement when a door closing operation of the door closer is in progress; and
adjusting, based on the at least one measurement, braking of the door closer to approach the target parameter;
wherein the target parameter comprises a target temperature proximate to a temperature-sensitive component, wherein the at least one measurement comprises a current temperature proximate to the temperature-sensitive component; and
wherein adjusting the braking comprises avoiding connecting an impedance proximate to the temperature-sensitive component when the current temperature proximate to the temperature-sensitive component is greater than the target temperature proximate to the temperature-sensitive component.

23. The method according to claim 22, wherein the target parameter comprises a door closing duration.

24. The method according to claim 22, wherein the target parameter comprises a door closing speed that varies depending on an opening angle of the door.

25. The method according to claim 22, wherein adjusting the braking comprises adjusting an impedance as seen from the generator.

26. The method according to claim 25, wherein adjusting the impedance as seen from the generator comprises applying pulse width modulation.

27. The method according to claim 25, wherein the generator is a multi-phase generator, and wherein adjusting the impedance as seen from the generator comprises short-circuiting at least two phases of the generator.

28. The method according to claim 27, wherein adjusting the impedance as seen from the generator comprises short-circuiting all phases of the generator.

29. The method according to claim 25, wherein adjusting the impedance as seen from the generator comprises adjusting an impedance between the generator and the energy storage device.

30. The method according to claim 29, wherein adjusting the impedance between the generator and the energy storage device comprises connecting or disconnecting at least one impedance between the generator and the energy storage device.

31. The method according to claim 22, wherein the target parameter comprises a target amount of energy stored in the energy storage device, wherein the at least one measurement comprises a current amount of energy stored in the energy storage device, and wherein adjusting the braking comprises adjusting the braking to reduce energy transfer from the generator to the energy storage device when the current amount of energy stored in the energy storage device is greater than the target amount of energy.

32. The method according to claim 22, wherein the target parameter comprises a target amount of energy stored in the energy storage device, wherein the at least one measurement comprises a current amount of energy stored in the energy storage device, and wherein adjusting the braking comprises adjusting the braking to increase energy transfer from the generator to the energy storage device when the current amount of energy stored in the energy storage device is less than the target amount of energy.

33. The method according to claim 22, wherein the target parameter comprises a target amount of energy stored in the energy storage device, and wherein the method further comprises using the generator for energy capture during opening of the door when a current amount of energy stored in the energy storage device is less than the target amount of energy.

34. The method according to claim 22, further comprising:
determining an applied braking is insufficient; and
sending a signal indicating that an abnormal braking is required.

35. The method according to claim 34, wherein the applied braking is insufficient when the applied braking is above a threshold amount of braking.

36. The method according to claim 34, wherein the applied braking is insufficient when the applied braking is not sufficient for the target parameter to be reached.

37. The method according to claim 22, wherein obtaining the at least one measurement and adjusting the braking of the door closer are repeated a plurality of times during the door closing operation.

38. The method according to claim 22, further comprising, prior to obtaining the at least one measurement:
measuring a first baseline duration, indicating a duration of closing the door during maximum braking of the door closer; and
measuring a second baseline duration, indicating a duration of closing the door during minimum braking of the door closer.

39. A door closer for closing a door, the door closer comprising:
a generator;
an energy storage device;
a processor; and
a memory storing instructions that, when executed by the processor, cause the door closer to:
obtain a target parameter for the door closer;
obtain at least one measurement when a door closing operation of the door closer is in progress; and
adjust, based on the at least one measurement, braking of the door closer to approach the target parameter;
wherein the target parameter comprises a target temperature proximate to a temperature-sensitive component, wherein the at least one measurement comprises a current temperature proximate to the temperature-sensitive component; and
wherein the instructions to adjust the braking comprise instructions that, when executed by the processor, cause the door closer to avoid connecting an impedance proximate to the temperature-sensitive component when the current temperature proximate to the temperature-sensitive component is greater than the target temperature proximate to the temperature-sensitive component.

40. A non-transitory computer readable medium storing a computer program for managing a door closer for closing a door, the door closer comprising a generator and an energy storage device, the computer program comprising computer program code which, when executed on the door closer, causes the door closer to:
obtain a target parameter for the door closer;
obtain at least one measurement when a door closing operation of the door closer is in progress; and
adjust, based on the at least one parameter, braking of the door closer to approach the target parameter;
wherein the target parameter is a target temperature proximate to a temperature-sensitive component, wherein the at least one measurement comprises a current temperature proximate to a temperature-sensitive component; and
wherein the computer program code to adjust the braking comprises computer program code which, when executed on the door closer, causes the door closer to avoid connecting an impedance proximate to the temperature-sensitive component when the current temperature proximate to a temperature-sensitive component is greater than the target temperature proximate to the temperature-sensitive component.
